(19) United States
(12) Patent Application Publication
(10) Pub. No.: US 2014/0218922 A1
(43) Pub. Date: Aug. 7, 2014

(54) LIGHTING METHOD FOR AN LED LIGHTING APPARATUS

(71) Applicant: KMW INC., Hwaseong (KR)

(72) Inventor: Duk Yong Kim, Yongin (KR)

(73) Assignee: KMW INC., Hwaseong (KR)

(21) Appl. No.: 14/245,434

(22) Filed: Apr. 4, 2014

Related U.S. Application Data
(63) Continuation of application No. PCT/KR2012/008091, filed on Oct. 5, 2012.

(30) Foreign Application Priority Data
Oct. 5, 2011 (KR) 10-2011-0101421

(51) Int. Cl. F21K 99/00

(52) U.S. Cl. CPC F21K 9/50
USPC 362/249.02

(57) ABSTRACT

The present invention relates to a lighting method for an LED lighting apparatus, in which e.g. an LED for illuminating an edge of a light distribution pattern far away from a street lamp has a relatively larger illumination angle and a smaller radiation angle, and an LED for illuminating the center of a light distribution pattern near the street lamp and an edge of a light distribution pattern adjacent to the street lamp has a relatively smaller illumination angle and a smaller radiation angle. Thus, each LED illuminates different areas of the road, thereby ensuring the uniformity of illumination of an overall light distribution pattern.

### CROSS-REFERENCE TO RELATED APPLICATION

The present application is a continuation of International Application No. PCT/KR2012/008091 filed on Oct. 5, 2012, which claims priority to Korean Application No. 10-2011-0101421 filed on Oct. 5, 2011, which applications are incorporated herein by reference.

### TECHNICAL FIELD

The present invention relates to a lighting method of an LED lighting apparatus, and more particularly to a lighting method of an LED lighting apparatus which can provide an optimized illumination to a road or an interior of a building while minimizing consumption of energy.

### BACKGROUND ART

In recent years, development of lighting apparatuses using an LED as a light source has been accelerated, considering that existing lighting apparatuses consume much electric power and should be frequently replaced due to their short life spans.

The lighting apparatuses currently using an LED as a light source employ lenses having various shapes or for various purposes to satisfy light distribution patterns ruled according to the use purposes of the lighting apparatuses.

For example, efforts are made to divide a board to which LEDs are mounted to divide the shape of a housing to which boards are coupled into a plurality of parts in order to adjust installation angles of the boards. However, when the board surface of the housing is divided into a plurality of parts, the thickness of the lighting apparatus becomes relatively larger and the weight of the lighting apparatus increases.

Further, although a method of using lenses to satisfy the ruled light distribution patterns is also widely used, a relatively high power LED should be used to satisfy a ruled intensity of illumination due to loss of light when the lens is used.

In particular, street lamps are installed at sides of a road to be spaced apart from each other and an area of the road which should be illuminated by one street lamp is wide.

A general street lamp has a light distribution pattern having an elliptical shape a length of which is longer along a lengthwise direction of a road, that is, toward an adjacent street lamp thereof. Further, when a street lamp is installed, an intensity of illumination on a road surface of a road is ruled.

The street lamp having the elliptical light distribution pattern has a difference between the intensity of illumination on a road surface adjacent to the street lamp and the intensity of illumination on a road surface farthest away from the street lamp. In this way, when the intensity of illumination at an edge of the light distribution pattern farthest from the street lamp agrees with the ruled intensity of illumination of a road surface, the intensity of illumination at a central portion of the light distribution pattern adjacent to the street lamp is higher than the rule.

In this way, the high intensity of illumination may cause a glare in the eyes of a driver, and may influence the driver of a vehicle travelling on another adjacent road. Further, power consumption may increase unnecessarily as the intensity of illumination is higher than the rule.

Furthermore, when a factory lamp illuminates a space having a wide interior area, the factory lamp disposed at an edge of the interior of the factory, for example, the factory lamp disposed near a wall of the factory unnecessarily illuminates the wall, decreasing efficiency.

Korean Patent Application Publication No. 10-2011-0008522 (published on Jan. 27, 2011) discloses an invention in which a light distribution pattern for illuminating a road is divided such that an LED lighting apparatus illuminates corners of the divided areas.

However, since the LED chips emit light at a light emission angle of 120 degrees and the difference between the intensities of illumination according to the distances from the LED chips to the locations of the light distribution chips is not considered, the difference between the intensities of illumination according to the locations of the light distribution pattern cannot be overcome.

Hereinafter, the problems of the illumination apparatuses according to the related art will be described in detail with reference to the accompanying drawings.

FIG. 1 is a view for explaining a problem of a lighting method of a lighting apparatus according to the related art.

Referring to FIG. 1, street lamps SL1 and SL2 are generally installed to be spaced apart from each other by a separation of 50 m, and a maximum diameter of a light distribution pattern of one street lamp is theoretically 50 m.

However, the light distribution patterns LP1 and LP2 of the street lamps SL1 and SL2 are elliptical, and some portions of the adjacent light distribution patterns LP1 and LP2 overlap each other to prevent a blind spot area of the light pattern. Accordingly, a maximum diameter of the light distribution patterns SL1 and SL2 exceeds 50 m.

Although the intensity of illumination on a road surface may agree with a ruled intensity of illumination, the intensity of illumination of an area B1 adjacent to the light source of the street lamp SL1 exceeds the ruled value to be a higher intensity of illumination.

As described above, the road surface whose intensity of illumination exceeds the rule may cause a glare in the eyes of the driver, and the other areas B2 and B3 may be mistaken as dark places and power consumption may become excessive.

FIG. 2 is a view for explaining a problem of Korean Patent Application Publication No. 10-2011-0008522.

Referring to FIG. 2, Korean Patent Application Publication No. 10-2011-0008522 (hereinafter, ‘Prior Art 1’) is configured such that LEDs are disposed in a matrix form in a lamp mechanism of a street lamp and an illumination area also is divided into a matrix form so that each of the LEDs illuminates one section.

Then, an LED LEDA located at the most distant location from a lamp pole illuminates the divided road surfaces A1, A2, A3, and A4 at the farthest distance from the lamp pole.

However, since the road surface A4 which is more distant from the lamp pole is more distant from the road A1, their intensities of illumination are different even though the LEDs arranged in a row of the LED LEDA illuminate the road surfaces A1 to A4.

In addition, since road surfaces B1, B2, B3, and B4 adjacent to the pole of the street lamp are illuminated by an LED LEDB, the road surfaces B1, B2, B3, and B4 have the same problem as that of the road surfaces A1 to A4. Further, since all the divided road surfaces A1 to A4 and B1 to B4 are divided into the same area, the intensities of illumination of the road surfaces B1 to B4 adjacent to the pole of the street lamp and the most distant road surfaces A1 to A4 also are different.

### SUMMARY

The present invention has been made in an effort to solve the above-mentioned problems, and it is an object of the present invention to provide a lighting method of an LED lighting apparatus in which set surfaces of a divided road surface are illuminated by an LED or a group of LEDs, and the areas of the set surfaces of the divided road surfaces are different such that the set surfaces of the divided road surfaces may be illuminated by adjusting illumination angles and radiation angles of the LEDs.

In accordance with an aspect of the present invention, there is provided a lighting method of an LED lighting apparatus wherein a plurality of LEDs illuminate divided patterns of light distributed patterns, and the divided light distribution patterns are illuminated by adjusting illumination angles and radiation angles of light radiated from the LEDs.

In the lighting method of an LED lighting apparatus according to the present invention, an LED illuminating an edge of a light distribution pattern distant from a street lamp has a relatively large illumination angle and a small radiation angle and a central portion of a light distribution pattern near the street lamp and an edge of a light distribution pattern adjacent to the street lamp have relatively small illumination angles and large radiation angles, so that the areas or interior areas of the roads illuminated by the LEDs are different, making it possible to uniformly secure the intensities of illumination of the entire light distribution patterns.

In this way, power consumption can be further reduced by securing the uniformity in the intensities of illumination of the light distribution patterns. Further, a road surface or an interior surface which is determined to be relatively dark by the driver or the user in spite that the intensities of illumination agree with a rule can be prevented from being generated due to the partial differences of illumination, which helps safe driving.

Further, a glare due to a higher intensity of illumination in some areas can be prevented from being generated. In addition, the driver of another vehicle traveling on another adjacent road can be prevented from being influenced, by concentrating light only on an illuminated area, which helps safe driving.

In addition, illumination efficiency can be increased by concentrating light on a surface which requires illumination other than a wall in a factory located near the wall of an interior of a building.

### BRIEF DESCRIPTION OF THE DRAWINGS

FIG. 1 is a view for explaining a problem of a lighting method of a lighting apparatus according to the related art.

FIG. 2 is a view for explaining a problem of prior art 1.

FIG. 3 is a view for explaining a lighting method according to an exemplary embodiment of the present invention.

FIGS. 4 and 5 are views for explaining a relationship between radiation angles and illumination angles according to distances in the present invention.

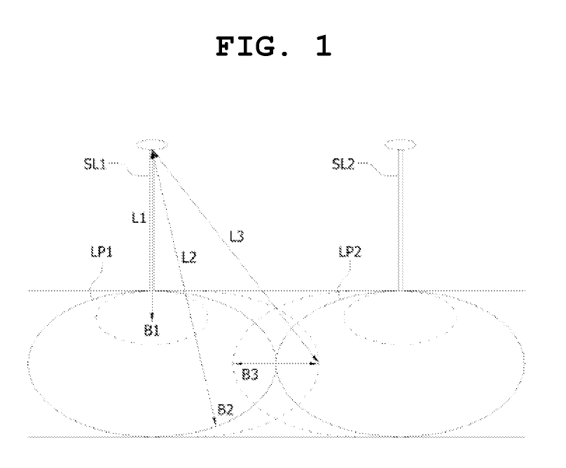

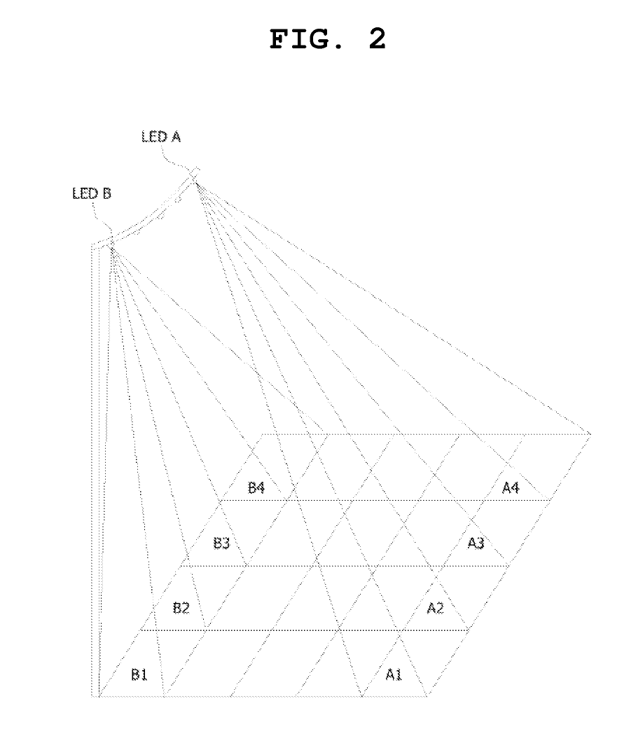

### DETAILED DESCRIPTION

Hereinafter, an LED light apparatus and a lighting method using the same according to the present invention will be described in detail with reference to the accompanying drawings.

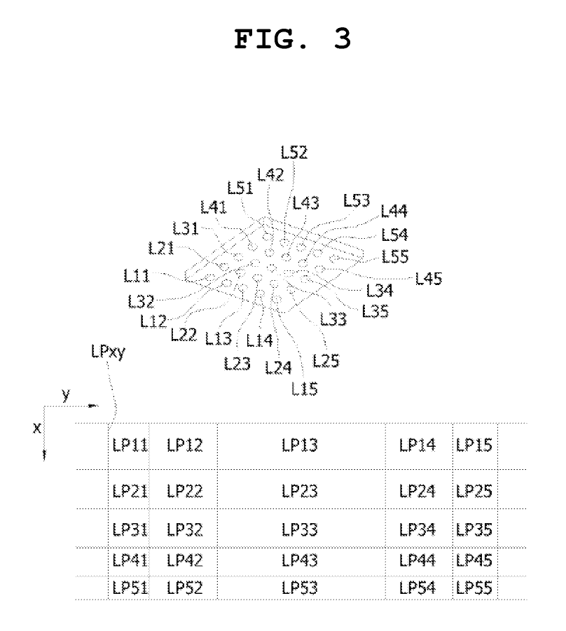

FIG. 3 is a view for explaining a lighting method according to an exemplary embodiment of the present invention.

Referring to FIG. 3, in the lighting method according to the embodiment of the present invention, a light distribution pattern (LPxy) of a street lamp 1, in which a plurality of LEDs L11 to L15, L21 to L25, L31 to L35, L41 to L45, and L51 to L55 (hereinafter, the entire LEDs are denoted by Lxy) are arranged in a matrix form, is divided into a plurality of parts corresponding to the number of the plurality of LEDs Lxy such that the LEDs Lxy light the divided light distribution patterns LPxy, and areas of the divided light distribution patterns which are more distant from the street lamp 1 are smaller than areas of the light distribution patterns which are closer to the street lamp 1.

Although the street lamp arranged in a matrix form is exemplified in the embodiment of the present invention, the present invention is not limited thereto and may be applied to any lighting lamp having an arbitrary arrangement.

Although installation surfaces of the LEDs Lxy of the street lamp 1 are shown to be excessively large as compared with the light distribution patterns LPxy for convenience' sake, the street lamp 1 is very small as compared with the light distribution patterns LPxy, and thus light of the LEDs Lxy may be illuminated from one point to the divided areas of the light distribution patterns LPxy.

The light distribution patterns LPxy are divided into 25 areas corresponding to the number of the LEDs Lxy, and as shown in the drawing, the light distribution patterns LPxy are formed on the left and right sides and the front side of the street lamp 1. For convenience' sake, the front side of the street lamp 1 corresponds to the x direction and the lateral side thereof corresponds to the y direction, and the divided light distribution patterns LPxy (x and y are integers of 1 to 5) are shown.

The areas of the two divided light distribution patterns LP51 and LP55 which are most distant from the street lamp 1 are narrowest and the areas of the divided light distribution pattern LP13 adjacent to the street lamp 1 are largest, and the areas of the light distribution patterns become gradually smaller as they go from the largest light distribution pattern LP13 toward the left and right sides and the front side.

Since the two LEDs L51 and L55 lighting the divided light distribution patterns LP51 and LP55 having the smallest areas should light the most distant areas, their intensities of light are low due to a difference between distances of light for reaching a road surface as compared with the other areas of the light distribution patterns LPxy in the same condition.

Then, since the areas of the light distribution patterns LP51 and LP55 are smallest, the radiation angles of the LEDs L51 and L55 may be smaller than the radiation angles of the other LEDs Lxy (x and y are 1 to 5 except that xy is 51 or 55), and when the radiation angles are small, a higher intensity of illumination may be obtained as compared with the wide radiation angles in a condition in which the same distance is illuminated.

Thus, by adjusting the radiation angles of the divided light distribution patterns LP51 and LP55 located at the farthest distance, the light distribution patterns LP51 and LP55 may provide the same intensity of illumination as that of the other areas of the light distribution patterns LPxy.

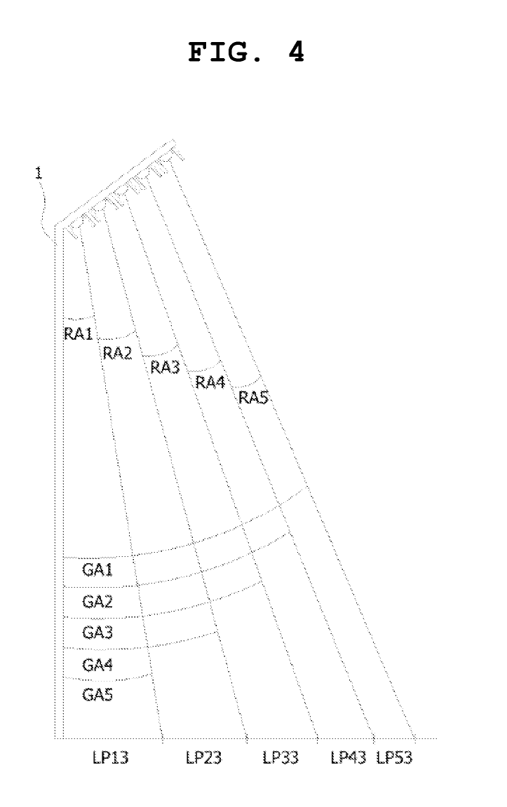

FIG. 4 is a view for explaining a relationship between radiation angles and illumination angles according to distances in the present invention.

Referring to FIG. 4, the LEDs L13, L23, L33, L43, and L53 in the central row of the LEDs Lxy illuminate the divided light distribution patterns LP13, LP23, LP33, LP43, and LP53.

Then, the illumination angle GA5 of the LED L53 illuminating the light distribution pattern LP53 which is farthest in the corresponding row from a pole of the street lamp 1 is larger than those of the LEDs L13 to L43, and the radiation angle RA5 which is a light emission angle of the LED L53 is the smallest of the radiation angles RA1 to RA5 of the LEDs L13 to L43.

Thus, among the intensities of illumination at locations spaced from the LEDs L13 to L53 by the same distance, the intensity of illumination of the LED L53 is highest and the intensity of illumination of the LED L13 emitting light at the largest radiation angle RA1 is lowest.

The differences in the intensities of illumination become uniform on the road surface having the light distribution patterns LP13, LP23, LP33, LP43, and LP53 due to the differences in the distances from the street lamp 1 to the divided light distribution patterns LP13, LP23, LP33, LP43, and LP53.

Due to this, the areas of the light distribution patterns LP13, LP23, LP33, LP43, and LP53 become smaller as they go far away from the street lamp 1. This can be regarded as the differences in the areas according to the radiation angles RA1 to RA5 of the LEDs L13, L23, L33, L43, and L53.

As described above, FIG. 4 is an exploded view of a surface on which the LEDs L13, L23, L33, L43, and L53 are disposed and is substantially the same as the case in which the LEDs L13, L23, L33, L43, and L53 illuminate light to the light distribution patterns LP13, LP23, LP33, LP43, and LP53.

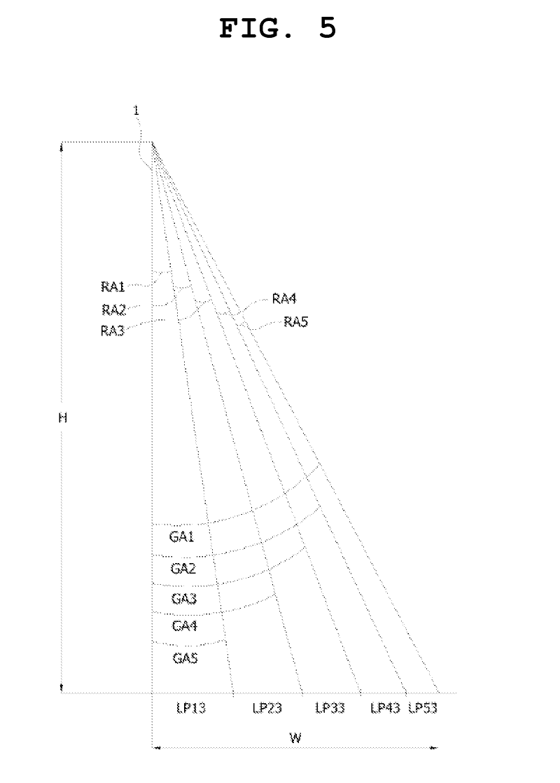

In FIG. 5, the height H of the lighting lamp 1 and the total width of the light distribution patterns LP13, LP23, LP33, LP43, and LP53 are fixed values in design of the road, and the illumination angles GA1 to GA5 and the radiation angles RA1 to RA5 of the LEDs L13, L23, L33, L43, and L53 are adjusted to obtain a uniform intensity of illumination while the light of the LEDs L13, L23, L33, L43, and L53 do not overlap each other.

In this way, according to the present invention, the entire light distribution patterns can be illuminated at a uniform intensity of illumination by adjusting the radiation angles of the LEDs as well as the illumination angles of the LEDs.

It will be appreciated by those skilled in the art to which the present invention pertains that the present invention is not limited to the embodiments and can be variously adjusted and modified without departing from the technical spirit of the present invention.

Since the present invention can secure a uniform intensity of illumination of the entire light distribution patterns by making the areas of a road illuminated by a plurality of LEDs in an LED lighting apparatus, it is industrially applicable.

1. A lighting method, wherein a plurality of LEDs illuminate divided patterns of light distribution patterns, and the divided light distribution patterns are illuminated by adjusting illumination angles and radiation angles of light radiated from the LEDs.

2. The lighting method of claim 1, wherein the light distribution patterns are divided such that areas of the light distribution patterns which are more distant from the LEDS are smaller.

3. The lighting method of claim 2, wherein the distribution patterns are divided to have rectangular or square shapes.

4. The lighting method of claim 1, wherein the illumination angles of the LEDs illuminating the light distribution patterns which are more distant from the LEDs are larger.

5. The lighting method of claim 1, wherein the radiation angles of the LEDs illuminating the light distribution patterns which are more distant from the LEDs are smaller.
